(19) United States
(12) Patent Application Publication
(10) Pub. No.: US 2020/0051185 A1
(43) Pub. Date: Feb. 13, 2020

(54) IMPROVEMENTS IN ENERGY MONITORING

(71) Applicant: ENVIRONMENT PARTNERS PTY LTD, West Melbourne, Victoria (AU)

(72) Inventors: David Hayden COLLINS, Parkville, Victoria (AU); Jonathon Haden GRiGG, Halls Head, Western Australia (AU); James FORSYTH, Cheltenham, Victoria (AU); Nathan Guy BATHAM, Tyalgum, NSW (AU)

(73) Assignee: ENVIRONMENT PARTNERS PTY LTD, West Melbourne, Victoria (AU)

(21) Appl. No.: 16/498,290

(22) PCT Filed: Apr. 3, 2018
(86) PCT No.: PCT/AU2018/000048

§ 371 Date: Sep. 26, 2019

(30) Foreign Application Priority Data
Mar. 31, 2017 (AU) 2017901190

(51) Int. Cl. G06Q 50/06; H04W 12/06; H04W 12/00; G06K 7/10; G06Q 40/02; G01R 19/25

(52) U.S. Cl. CPC G06Q 50/06; H04W 12/06; H04W 12/003; G01R 19/2513; G06K 7/10366; G06K 7/10297; G06Q 40/02; H04W 12/00407

(57) ABSTRACT

Disclosed herein are embodiments of systems and methods for monitoring and managing the supply and use of electric power and related resources and for monitoring and managing electric power consumption by individual persons. One embodiment, for example, is directed to a system for distributing and monitoring usage of energy comprising at least one power distribution unit, connectable to an energy source and to one or more energy-consuming devices, and adapted to monitor energy distribution from the energy source through the or each power distribution unit. The system may also include at least one server in communication with the at least one power distribution network via a data network, adapted to receive through the data network data on energy distributed by the or each power distribution unit to the energy-consuming devices.

### SCOPE

The invention relates to systems and methods for monitoring and managing the supply and use of electric power and related resources, and in particular to providing for monitoring and management of usage and consumption by individual persons.

### BACKGROUND

This invention is directed to systems for measurement and management of energy and related resources by individuals mainly in buildings, parts of buildings, and other spaces in which numerous individuals work. This focus on the energy usage of individual persons is to be distinguished from, but may be additional to, monitoring and management of devices and systems.

Although likely to find most use in the management of energy usage and power demand in commercial buildings and organisations, the invention could in principle, apply in multiple occupancy residential buildings and the like, even the family home.

The invention is directed to improvements in systems, equipment and methods for monitoring and control of energy and related resource use where it is desired not only to monitor enterprises and groupings within them, but individual persons. When a person can find out their own personal energy usage, they are likely to have an enhanced incentive to reduce it, particularly if derivative information such as “greenhouse gas emissions footprint” is provided. Moreover, the management of an enterprise, if provided with information at the individual-person level, will be better able to pinpoint areas for possible improvement.

In some situations, this may go beyond simple monitoring, with individuals being provided with an energy usage “budget” or target or even being charged for their usage. An example of the latter would be an office having within it workstations that are rented to individual persons, who naturally wish to pay only for what they use, so far as that is possible.

It should be noted that while it is possible to monitor energy and power usage by individual devices, that is not necessarily the same as monitoring usage by individual persons. A photocopier in an office may be used by many persons, for example.

With increasing interest by many people in their overall personal energy usage and related greenhouse gas emissions footprint, it is possible for information collected at an individual's work place to be provided to them without necessarily divulging information on the enterprise as a whole or larger (for example departmental) groupings within it, which may be considered sensitive. The invention addresses this aspect also.

### DISCLOSURE OF THE INVENTION

In one aspect, the invention provides a system for distribution of electric power from a source of electric power to electrically powered devices comprising

a power distribution unit connectable to the source of electric power and having at least one power outlet adapted for connection of electrically powered devices;
wherein the power distribution unit comprises:
at least one sensor for monitoring of electric power transmitted through the power distribution unit;
communication means whereby information derived from the at least one sensor is transmitted to a receiving device;
control means for permitting and interrupting a flow of electric power from the electric power source to the at least one power outlet, the control means operable by a signal received from an authorizing device,
and wherein the control means permits the flow of electric power only after a user is authorised in a process executed by at least one of the authorizing device and the power distribution unit.

In another aspect, the invention provides a power distribution unit connectable to a source of power and having at least one power outlet adapted for connection of electrically powered devices and comprising:

at least one sensor for monitoring of electric power transmitted through the power distribution unit;
communication means whereby information derived from the at least one sensor is transmitted to a receiving device;
control means for permitting and interrupting a flow of electric power from the electric power source to the at least one power outlet, the control means operable by a signal received from an authorizing device,
and wherein the control means permits the flow of electric power only after a user is authorised in a process executed by at least one of the authorizing device and the power distribution unit.

In a further aspect, the invention provides a method for distribution of electric power from a source of electric power to electrically powered devices comprising the steps of:

connecting the source of electric power to a power distribution unit having at least one power outlet adapted for connection of electrically powered devices;
connecting to the at least one power outlet at least one electrically powered device;
wherein the power distribution unit comprises:
at least one sensor for monitoring of electric power transmitted through the power distribution unit;
communication means whereby information derived from the at least one sensor is transmitted to a receiving device;
control means for permitting and interrupting a flow of electric power from the electric power source to the at least one power outlet, the control means operable by a signal received from an authorizing device,
and wherein the method further comprises the step of the control means permitting the flow of electric power only after a user is authorised in a process executed by at least one of the authorizing device and the power distribution unit.

The power distribution unit in some embodiments is adapted to connect to the source of electric power by being plugged into a wall socket.

The power distribution unit in some embodiments is comprised in an assembly that includes or is connected to a wall socket.

The source of electric power may be or include an external source of mains electric power, for example providing single phase AC at approximately 240V or 115V.

Preferably the power distribution unit comprises a power supply adapted to power at least the data processing and communication means, the authentication means, the sensor means (if required) and any means for control within the power distribution unit of power distribution through the or each power outlet using power derived from electric power entering the power distribution unit via the power connection means. However, this is not to preclude the alternative (or additional) possibility of powering any or all of these items using an internal battery or power derived from a wired data network connection (e.g., Power-over-Ethernet).

Authentication to enable of power delivery from the power distribution unit may be by any suitable method based on possession of a secret (for example a password or answer to a challenge question), possession of a uniquely identifying device (for example a computer or smartphone) or object (for example a RFID or NFC tag, fob or card), or “possession” of a property such as a fingerprint, facial feature or the iris characteristic.

Once a person has activated a power distribution unit by a process of authenticating his, her or a grouping's authority to receive power through the unit, an identifier unique to that person or grouping becomes available for sending onto the data network with sensor data or information derived therefrom. A server connected through the data network to the server has stored thereon a list of authorized persons and/or groupings so as to be able to collate information on power and energy usage for those persons or groupings.

The power distribution unit may be adapted to sense characteristics of the power flowing through the power distribution unit as a whole. Alternatively, where there are several power outlets, sensors may be provided to sense such characteristics of the power flow to each individual power outlet separately. In this case, the power distribution unit may be configured (including in respect of software of the control means) to transmit via the data network data and/or derived information for individual power outlets.

This can be achieved without any need for the power distribution unit to have more than one MAC address. (A person skilled in the art will readily understand that where the unit has one MAC address only, it is still possible for data relating to, and instructions for control of, individual power outlets to be transmitted through the data network.)

The power distribution unit may have several data network connection and communication means rather than just one. For example, it may be provided with both Ethernet and WiFi capabilities.

The invention will be described below in more detail by reference to the following Figures.

In this specification, the word “comprise” and derivatives thereof (for example “comprises”, “comprising”, “comprised in”) when used in relation to elements or steps are to be taken as indicating the presence of those elements or steps, but not to preclude the possible presence of other elements or steps.

### DRAWINGS

FIG. 1 is a schematic (block) diagram of the flow of electric power from a power source to power consuming devices in an office space, being an example of the application of the invention.

FIG. 2 is a block diagram of an electric power distribution unit according to the invention.

FIG. 3 is a perspective view of an electric power distribution unit according to the invention.

FIG. 4 is a schematic (block) diagram of a server comprised in the system of FIG. 1, showing component software/data modules.

FIG. 5 is a perspective view of a further electric power distribution unit according to the invention.

FIG. 6 is a sectional view of a rotatable power outlet socket assembly optionally comprised in an electric power distribution unit of FIG. 3 according to the invention.

FIG. 7 is a view in the direction of arrow “A” in FIG. 6.

FIG. 8 is a perspective view of a further power distribution unit and a mating conventional wall socket.

FIG. 9 is a schematic diagram of an authentication scheme of some embodiments.

FIG. 10 is a schematic diagram of a further authentication scheme that is an alternative to the scheme is a schematic diagram of a still further authentication scheme that is an alternative to the schemes of FIGS. 9 and 10.

FIG. 12 is a schematic diagram of a yet further authentication scheme that is an alternative to the schemes of FIGS. 9, 10 and 11.

FIG. 13 is a perspective view of a mobile phone and a desktop inductive charger usable for the mobile phone and in embodiments of the invention.

### DETAILED DESCRIPTION OF PREFERRED EMBODIMENTS

For ease of understanding and description, the invention will be described by reference to a particular possible application. However, it is to be understood that this approach is in no way to be taken as limiting the invention to that application. Persons skilled in the art will readily be able to recognize other suitable applications and to apply the invention to those applications.

The exemplary application comprises an office space in which are provided a number of workstations and enclosed offices used by individual persons. Within each workstation there may be several devices such as computers and peripherals such as monitors, printers, scanners and the like, which are normally used by the occupant only.

The office space also has some shared facilities such as a kitchen, bathroom, foyer/reception area, conference room and computer server room. There may be provided some other shared items such as a colour photocopier accessible to all or some of the persons working in the offices or workstations.

The office space also has lighting and HVAC (Heating, Ventilating, Air Conditioning) systems, 6 and 4 respectively. These may or may not be controllable to some degree by individual persons in the office space.

The office could be operated by a single enterprise, with all personnel in it being part of that enterprise. Another possibility is that the enterprise rents workstations and offices to other businesses, possibly including individual (one-person) enterprises.

An owner of such a space (or the management of an enterprise operating in it) may wish to determine energy usage and power demands in order to manage them for minimization of costs to the business. This may involve for example ensuring that consumption of “standby” power by devices is minimized by ensuring they are switched off when their users are not present, e.g., overnight. Or, it may be that some computer usage is made subject to scheduling so that it occurs during low-tariff periods, where this is possible. If the office space is supplied with electric power by a combination of renewable energy generating devices such as solar photovoltaic panels on the roof) it may be desired or necessary to minimize energy usage at certain times. The invention is adapted firstly to provide information on energy and power usage and in particular to enable this to be done for the office as a whole, or physical parts of the building or departments or teams or other groupings and even to individual persons, and even to charge for energy usage at any of these levels. Secondly, in some embodiments, control can be exercised over electrical devices connected to the power source.

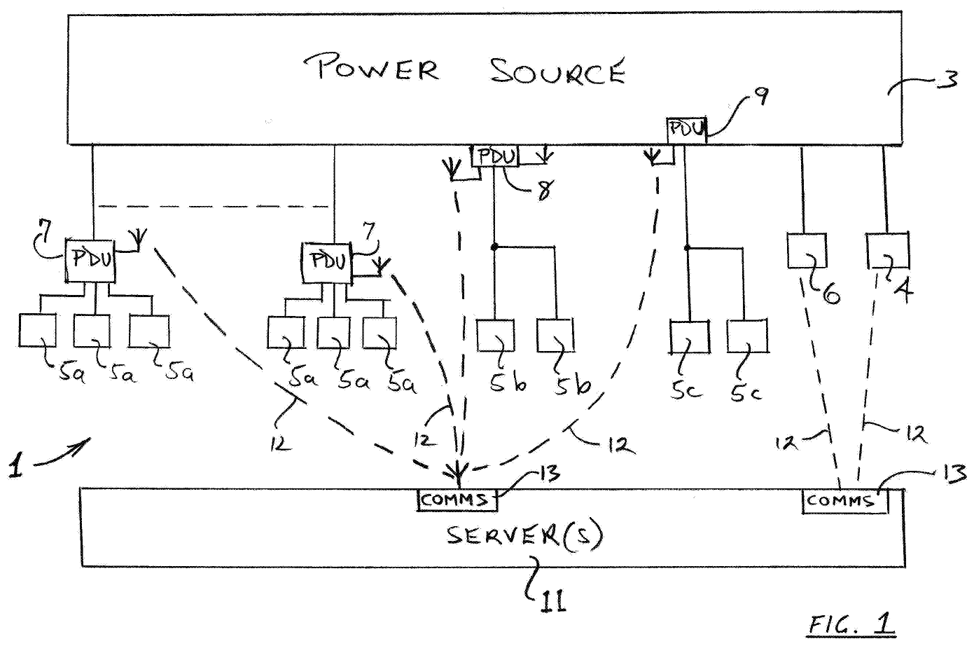

FIG. 1 is a schematic representation of power supply and usage management system 1 for such an office space. The supply of electric power from power source 3 (such as a mains power connection) to various “plug-in” electrically powered devices 5a, 5b and 5c is monitored by three different types of power distribution units (PDUs) 7, 8 and 9, while other electric equipment is permanently cabled in, such as heating ventilation and air conditioning plant 4 and lighting system 6 and monitored by other devices (not shown). Data links 12 (discussed below) and the various components (including devices 5a, 5b and 5c in some embodiments) in FIG. 1 excluding power source 3, amount to a data network.

The PDUs 7, 8 and 9 and monitoring equipment for items 4 and 6 are nodes of a data network that communicate with server(s) 11 which receive through communications devices 13, data on power/energy usage via data links 12. The data network is represented as a wireless (network, and as having a particular topology, but it is not intended that the network necessarily be limited to such an arrangement. Rather, any suitable network arrangement and technology may be used consistent with the description of equipment and methodology that follows. For example, the data network of system 1 could be a mesh network.

The server(s) 11 are provided with communications device(s) 13 and software to manage collection, recording and analysis of power and energy usage data from the PDUs 7, 8 and 9 and the equipment 4 and 6 together with other associated functions and authentication of users of the system. In the preferred arrangement, the server(s) 11 also provide for a degree of control of power supply from power source 3 to the plug-in electric devices 5a, 5b, 5c and equipment 4 and 6. For this reason, arrows 12 are intended to represent the data network providing two-way communication between the server(s) 11 and the PDUs 7, 8 and 9 and equipment 4 and 6.

The nodes of the data network of system 1 may be connected wirelessly or by wired or other means (e.g., fibre optic) and use any suitable topologies and communications protocols. For example (only) nodes may exchange data using (wired) Ethernet or (wireless) Zigbee or Wifi or Z-Wave protocols and equipment.

Where it is required to be possible to associate energy usage accurately to individual persons, and particularly if there is to be the possibility of charging them for that usage, merely detecting that they are in the office space (as can be done for example with a secure entry system for the office space) or that someone (not necessarily them) is present in their actual workstation or office, for example using a PIR sensor, or that a device normally used only by them is being used, is not sufficiently reliable. What is required is to provide means for ensuring that the usage of devices or facilities is treated correctly as being due to a particular person by an association process involving authentication of the association of user and device by the user. Embodiments of the invention therefore provide for individual workers to assume responsibility for energy/power usage by plug-in equipment 5a, 5b, 5c used by them, by providing for such an authentication process that is carried out as closely as possible to workers' actual work stations and by them, using the PDUs 7, 8 and 9. Data on such power/energy usage is delivered to the server(s) 11 for collation, analysis and reporting.

Three types of PDUs are described herein. Thus, for use in an individual worker's office, workstation or the like the invention firstly provides for a PDU 7 to be provided that connects to a source of electric power typically via a wall socket and to which one or more devices 5a (e.g., computer, printer, scanner, desk light) can be connected to have power distributed to them, with the PDU 7 having means to monitor power and energy flow through it, and having its own local means of authentication as described below. “Local” here means that the authenticated association process is effected by the person using PDU 7 at or near the location of PDU 7. Although it is possible for a PDU 7 to simply monitor energy and power usage at all times, in some embodiments, ending usage causes disconnection of devices 5a from the power source 3. PDUs 7, used in system 1, may conveniently be in the form of a “power strip” or “power board”, albeit with the additional presence of means for authentication.

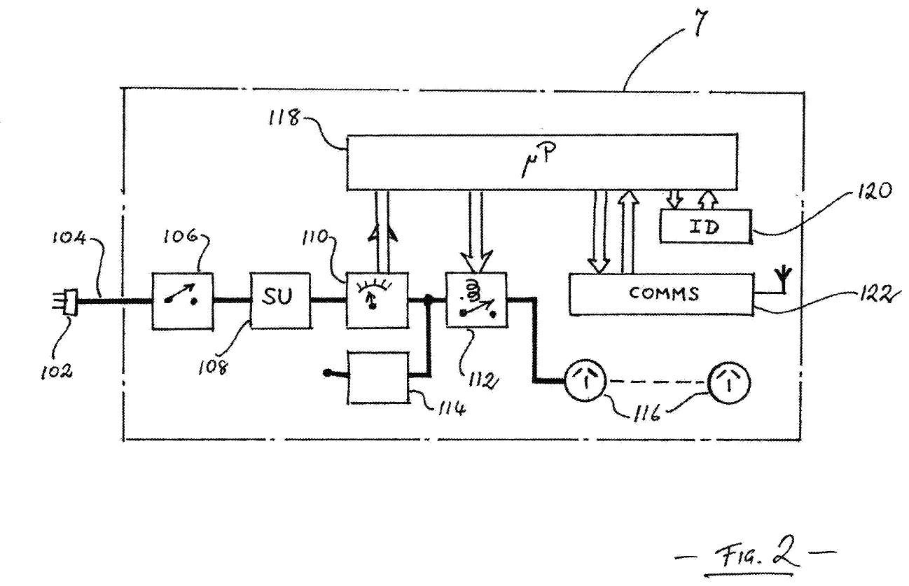

It is possible to provide in a workstation a power distribution unit with the functionality of PDU 7, comprising a number of standard mains power outlets built in to the workstation each having authentication means built in, or placed close by. However, the “power strip” or “power board” form is convenient and can be connected to (plugged into) a single power outlet and have multiple sockets for standard mains plugs. PDUs of this type and usable as PDUs 7 are described below by reference to FIGS. 2,3 and 5-7.

As described further below, PDUs 7 may be adapted to measure only the total power being taken by them from the power source 3 or the power being distributed through each or any one or any group of their outlet sockets, as required. (Energy usage is of course derivable as power demand integrated over time).

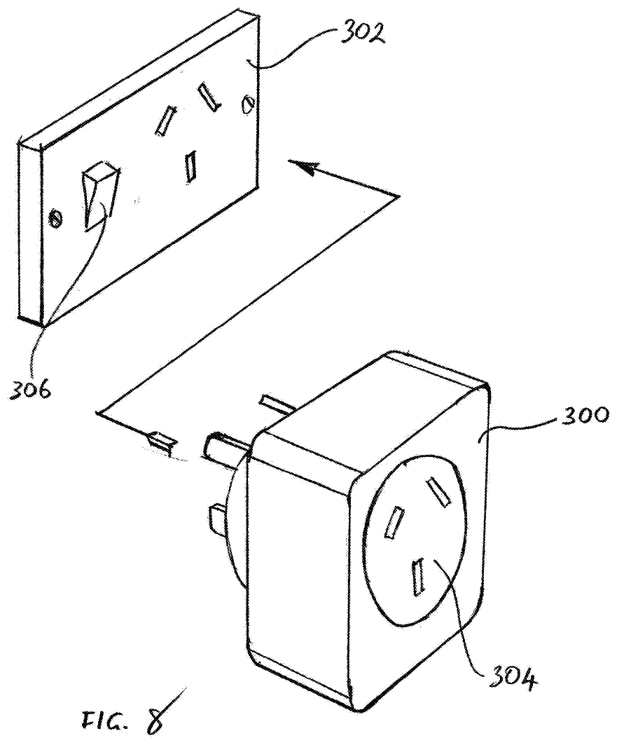

A second form of PDU is represented in FIG. 1 as item 8, and simply comprises a device that is functionally the same as PDUs 7 except that it has only one outlet socket. That is, it can sense power/energy being used by equipment connected to its outlet socket, communicate the sensed data over a data network and optionally be controllable by commands delivered over the same data network. FIG. 8 shows a PDU 300 of this type, having one outlet socket 304, and suitable for plugging into a conventional wall socket 302. The multi-socket PDU 7 described below has a cord 104 and plug 102 for connection to a wall socket (not shown) like conventional power strips, but this is unnecessary for a single socket version such as 300.

Single outlet PDUs such as 300 will not be described in detail, because they are in essence a special case of PDUs such as 7, which is described in adequate detail herein. Persons of ordinary skill in the art will readily be able to apply the teachings below in relation to PDU 7 to arrive at single-outlet PDUs such as 300.

A third form of PDU is represented in FIG. 1 as item 9 and also has one outlet socket only. Functionally this third form of PDU is exactly the same as PDU 300, being able to sense power/energy being used by equipment connected to its outlet socket, communicate the sensed data over a data network and optionally be controllable by commands delivered over the same data network. However, this type of PDU comprises an assembly that can simply replace a conventional outlet socket, being permanently wired into a wall or partition or the like in the same way. To a user, PDU 9 when installed would appear essentially the same as conventional wall socket 302 (FIG. 8) except that the switch 306 would be omitted, as unnecessary.

Single outlet PDUs such as 9 will not be described in detail, because they are in essence a special case of PDUs such as 7 and 300, and PDU 7 is described in adequate detail herein. Persons of ordinary skill in the art will readily be able to apply the teachings below in relation to PDU 7 to arrive at single-socket PDUs such as PDU 9.

Note that a further possibility is a PDU with multiple outlets, but that is also hard-wired. For example, a built-in PDU could have two outlet sockets instead of one, and replace a conventional dual-socket wall fitting. Such PDUs are within the scope of the invention also, but as they too can be arrived at following the teachings herein relating to PDU 7, they need not be described further herein.

In FIG. 1, some devices 5a are shown as connected to multi-socket PDUs 7, some (5b) to a single socket plug-in PDU 8 and some (5c) to a wired-in single socket PDU 9. In a given application, the choice of which type of PDU to use for monitoring plug-in devices' energy and power usage depends on a number of factors. If it is desired to monitor multiple devices' power/energy usage individually, PDUs 7 with the ability to monitor individual outlet sockets are convenient. If several devices can be powered from a single socket and need not be monitored individually, either PDU 8 or PDU 9 may be used. If in such a case there are not enough sockets available at a workstation for all devices that are to be used there, PDUs 7 can be used, or PDU 8 or 9 with a conventional power strip. PDUs 7 and 8 have the advantage that over PDU 9 that no electrical power wiring is required, potentially saving costs.

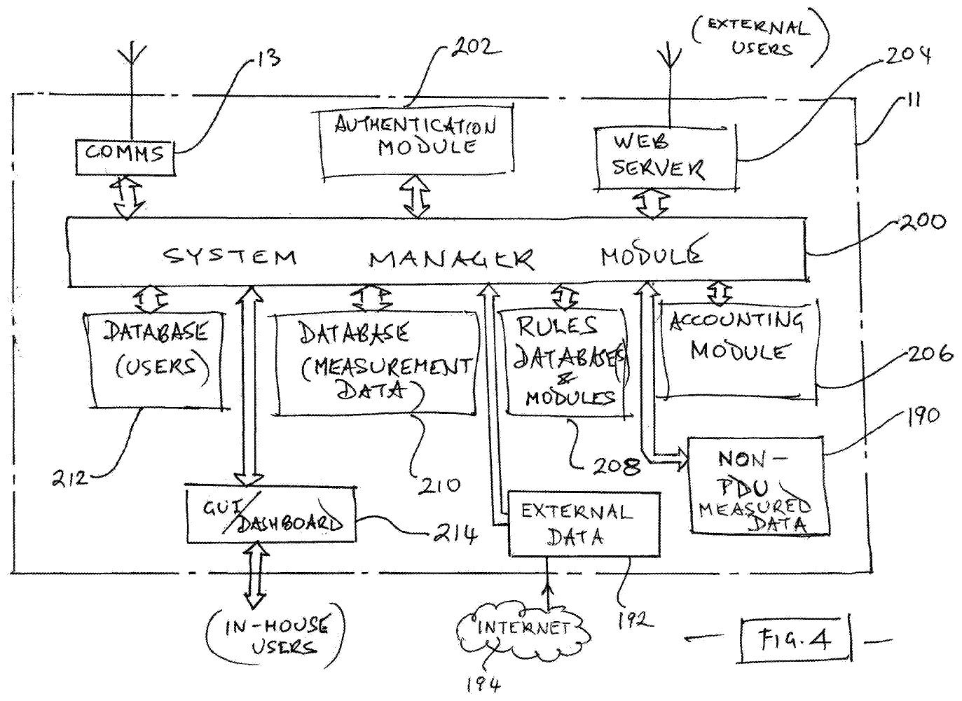

Before describing PDU 7 in detail, the functionality of the server(s) 11 of system 1 will be described, by reference to FIG. 4. Data logged by the monitoring PDUs 7, 8 and 9 and from monitoring of equipment 4 and 6 is received by the communications module 13 over the data links 12. Also received at 13 is data associated with authentication of usage of PDUs 7,8 and 9 as explained below. Such data is used by an authentication module 202 of the software installed in server 11. This is done under the control of a system manager module 200 of that software. A database 212 of authorized users of the system is accessed to determine whether an authorized user of a PDU 7, 8 or 9 has been detected as beginning a session of use or ending one, and if so, to issue a command to the relevant PDU 7, 8 or 9 to enable of disable connection to power source 3. Logging of power/energy usage takes place through such a session of use.

Data and/or derived information on energy usage is written to a database 210.

An accounting module 206 is provided for handling the allocation of energy usage to the office space 1 as a whole, and specified groupings (e.g., teams, departments) and individual persons, and, as applicable, progress against targets/budgets, charges to be made, and the like.

Depending on the intended sophistication of the system, databases or procedure modules 208 may be provided for containing or effecting:
(a) rules for management of the system based on logged usage data, for example how long to leave a PDU 7, 8 or 9 that shows the devices connected to it are idle before taking action by issuing suitable commands;
(b) optionally, saved characteristics of devices 5 or groups of devices, such as standby power demand so that a standby or idle condition can be recognized;
(c) membership of individual persons in designated groupings (e.g., team, department, enterprise, individual only, etc); and
(d) rules for allocation of energy/power usage to individual persons where the usage is not directly through a PDU 7, 8 or 9.

Regarding item (d), the rules depend on the nature of the power/energy usage that is to be allocated. Thus for the HVAC 4, and lighting 6 systems, individuals in the office may have no ability to control them, and a simple “equal share” rule may be implemented, in which every individual office user is taken to have benefited from these systems for the period of their presence in the office. However, if there is a system that allows individuals' location in the office at any time to be determined, that may be used in a more refined estimate. Similarly, if individuals have a degree of personal control over shared systems such as 4 and 6, still more refined estimation rules may be provided if the individual use can be monitored—for example by monitoring temperatures or thermostat settings at workstations.

Similarly, energy usage of a device such as a photocopier may be treated on an “equal shares” basis, but if metering of copies is available to an external device, a more refined estimation rule may be provided.

In the disclosure of authentication methods below, mention is made of the use of RFID tags and smart phones. These and other methodologies may also be used to determine individuals' locations in the office, and therefore be used in making or refining estimations of energy usage for shared systems. To this end, server(s) 11 is shown to maintain a database 190 of logged data on information received from monitoring of factors other than power/energy usage such as individuals' presence and location over time, HVAC settings and the like. Note that the system of FIG. 4 may interface with a security system (not shown) that can at least indicate whether an individual person is present in the office or not, a coarse indication of location.

A further module 214 provides for presentation in suitable form of logged and/or derived information, system management, settings entry, and the like.

As many people nowadays are interested to know information such as their personal energy usage, greenhouse gas emissions footprint and the like, provision may be made for such information to be provided, optionally in secured (e.g., encrypted) form, to individuals themselves, for example through the Internet, using a web server module 204, where and to the extent that is not considered confidential by the management of the enterprise operating office space 1.

To make greenhouse gas emissions information more meaningful, usage of other utilities, such as gas and water supply, may be monitored and used by server(s) 11. As for electricity usage, this monitoring may be done only at the whole-office level or, at an individual-person level, or at a level in between. It is possible today to obtain externally-made estimates of greenhouse gas emissions associated with gas and water supply for use in arriving at estimates of emissions associated with the office's or individuals' usage of these utilities, and to this end a module 192 is shown in FIG. 4 for information (which may for example be obtained through the Internet 194) usable in making such estimates. In some embodiments, module 192 also contains information on electricity tariffs and the like.

Taking this concept further still, it is possible with suitable privacy arrangements to collect bank account data in server 11 and to derive from them greenhouse gas emission or other derivative metrics.

In the application as shown in FIG. 1, PDUs 7, 8 and 9 measure electrical parameters associated with the flow of electricity through them, and communicate those parameters, or quantities derived from them, to server(s) 11 so that power demand and therefore energy usage can be recorded and analysed. They also transmit an identifier of users who have authenticated themselves, to server(s) 11. When the end of a period of usage by a particular user is signalled, or if a specified predetermined time has expired without power usage, power is disconnected from devices 5(a, b or c) by the relevant PDU. This may be done entirely locally within that PDU, or involve a “switch-off” command being sent from server 11 to that PDU.

PDUs such as 7, 8 and 9 may also be used elsewhere in office space 1 than in a workstation or office. For example, a conference room may have a set of audio or video facilities or other equipment items that are normally used together, and a PDU such as 7 can suitably be used for such sets. The PDU 7, 8 or 9 may replace wall switches in cases such as this.

However, some devices are shared between multiple users and may be required to operate without authentication by individual persons (other perhaps than a system administrator) and without direct allocation of energy usage to individuals. These devices may be monitored for power/energy usage without a requirement for user authentication or allocation of usage to any person or group. For example, server(s) 11 could be powered this way or a centralised HVAC system covering the office space. Of course, a PDU like PDUs 7, 8 or 9 could also be used, with authentication by for example a system administrator.

Still other devices may need to be used by many individual users from time to time, but be unsuitable or inconvenient for use in the way described above in relation to PDUs 7, 8 or 9 (with authentication for switch-on and authentication for a later switch-off). For example, coffee makers and boiling water heaters may require to be in a standby mode and then be used for a brief period. For such devices, an option can be to provide for a power monitoring device such as 8 or 9 with a “tap” or “swipe” authentication capability, wherein a user arrives at the device, and authenticates, but with the device then reverting to standby mode automatically after it detects that the machine has not been used for a predetermined period.

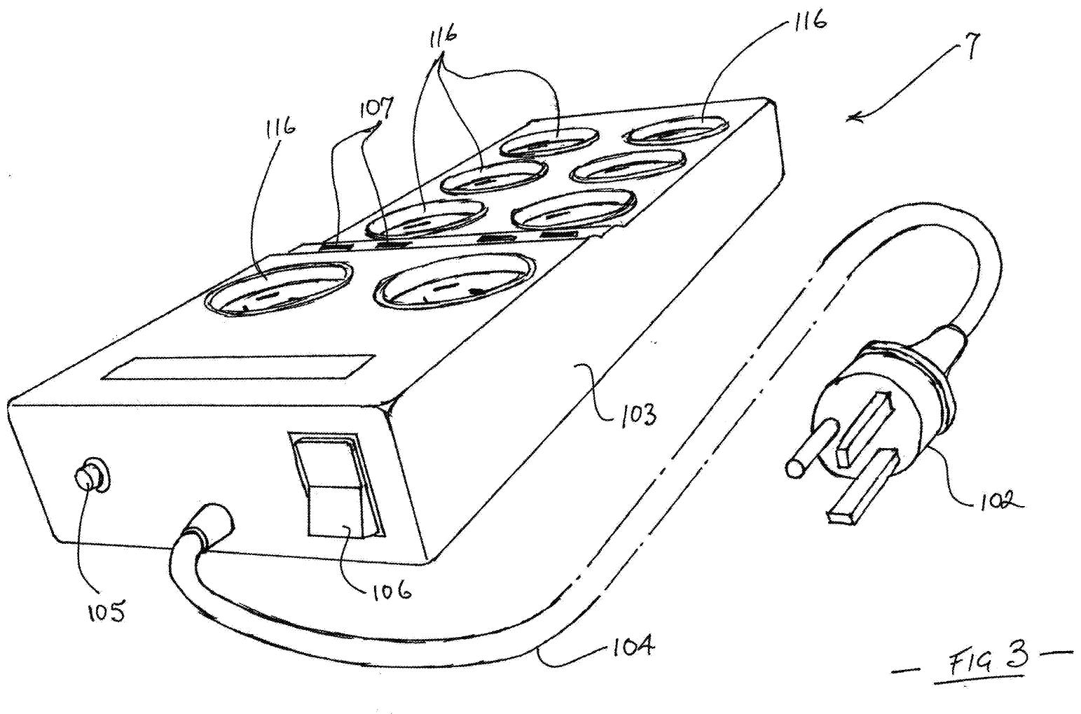

Embodiments of power distribution unit 7 will now be described. One possible configuration of a power distribution unit (PDU) 7 according to the invention is shown in the form of a block diagram in FIG. 2. FIG. 3 shows a particular possible form of the PDU 7, namely the form of a so-called “power strip” (or “power board”) having a casing 103 in which the various functional components discussed below are contained. Mains power is supplied to the PDU 7 through a plug 102 and power cord 104. A manually operated switch 106 is provided to enable the PDU to be disconnected by a user from mains power if required.

A surge protector 108 (for example of known varistor type) as known in conventional power strips is provided to protect the power strip and connected devices from power surges. A reset button (switch) 105 (not shown in FIG. 2) is preferably provided to enable restoration of power after an interruption that that trips the surge protector 108. Such provision for resetting is known in the power strip art.

A current sensor 110 senses the flow of current to a group of outlet sockets 116, the sensor's output being directed to microcontroller 118. Microcontroller 118 may be for example a suitable one of those sold under the brand name “Arduino”. It is by means of this current measurement that power and therefore energy usage of devices (not shown) connected to sockets 116 can be measured.

In the power wiring between the current sensor 110 and the sockets 116 is a switch 112 activated (for example using an electromagnetic relay) by microcontroller 118. Switch 112 enables supply of power to sockets 116 to be disabled or enabled by commands from the microcontroller. This functionality is optional if all that is required is for PDU 7 to enable monitoring of power/energy usage by devices connected to sockets 116, but does enable a higher level of energy management, for example disabling power supply when the devices connected to sockets 116 are not in use, and the power drain required to maintain the devices in standby mode is to be avoided.

Also communicating with the microcontroller 118 are one or more communications modules 122 and one or more user identification modules 120. For clarity, only one communication module 122 is shown, and only one user identification module 120. The communications module enables receipt of commands through, and the transfer of data derived from the current sensor 110 to, network 10.

The user identification module 120 enables the person (or group of persons) using PDU 7 for power supply to authenticate that it is he/she/they doing so and comprises the hardware components needed for this function (see below).

Also connected to the power wiring at the outlet of the current sensor 110 is a power supply module 114 comprising a transformer with suitable conditioning componentry (not shown) to provide low voltage DC for the microcontroller 118, communications and user identification modules 122 and 120 and, if required, for actuation of switch 112. Conveniently, power supply module 114 may also provide power to one or more charging sockets for 107 mobile phones or the like. These may for example be provided in one or more of the USB patterns (e.g., USB 2 or USB 3).

The plug 102 is shown as having a non-standard pin arrangement (as shown) that mates with a dedicated wall (or other) socket (not shown in FIG. 2) provided with mains power. The intention is to defeat unauthorized use of mains power, or at least use of mains power without monitoring by the PDU7, which could otherwise be done using a standard wall socket by simply plugging a power-consuming device directly into the standard wall socket instead of the PDU 7.

FIG. 2 shows the current sensor arranged to monitor the total current supplied to the group of power strip sockets 114. However, a person skilled in the art will readily appreciate that in an alternative arrangement (not shown), individual sockets 116 could be provided with their own current sensors, so that the energy usage of individual devices could be monitored.

Similarly, in another arrangement also not shown, each one of sockets 116 could, instead of the single switch 110, be provided with its own switch individually controllable by the microcontroller 112.

Various choices may also be made as to the provision of sensors. Use of the single current sensor 110 show in the arrangement of FIG. 2 implies that power demand (and when integrated over time, energy usage) is determined using an assumed voltage, being the nominal voltage of supply (e.g., 240V or 115V). However, it is possible instead to provide both voltage and current sensors so that variations in voltage do not lead to inaccuracy. Moreover, voltages and currents may be sensed, if desired, multiple times through a cycle and analysed (within PDU 7 or by servers 11) to provide more information, for example power factor.

Another enhancement that may be made if desired by the skilled person would be to provide for different arrangements as to remote switching of power to sockets 116. Thus, it is possible to provide that one or more sockets 116 are not able to be switched off by command from server(s) 11 while other sockets 116 can, so that critical devices are not normally disconnected except when the power source itself fails.

PDU 7 (and 8 and 9) may provide only for control of beginning and ending of power flow from power source 3 and monitoring of that power flow. However, additional capabilities may be provided as required either by the PDU 7, 8 or 9 alone or as part of system 1. For example, power supply to devices may be interrupted in the event that an overload condition is detected. For further example, system 1 may be provided with rules as to an order of precedence for power interruption in the case of excessive power consumption or in response to a contracted demand response (DR) arrangement with a power supplier. Automatic restarting or rebooting of designated devices after a power interruption may be provided for, as is known in the art of conventional power strips.

Arrangements for activation of PDU 7 by an intending user in an authentication process will now be described, by way of examples.

FIGS. 9 to 12 show several different ways in which the local authentication process can be effected.

For simplicity of description, FIGS. 9 to 12 are in block diagram form, without showing every item of hardware that would be required in practice. However, understanding and implementing the schemes shown, including providing the appropriate hardware and programming would be within the capabilities of a person skilled in the relevant art. Also for simplicity, the description will be based on switching on a wall socket (204, 222, 226, 244), i.e. a PDU of the type referred to above as type 9. However, it is to be understood that the authentication arrangements described are equally applicable to other types, such as PDUs 7 and 300.

Referring to FIG. 9, the authentication is made by means of a Radio-Frequency-Identification (RFID) tag 200, issued to the worker whose identity is to be authenticated. A suitable RFID tag reader 202 is provided at a conveniently accessible point in the vicinity of the socket 204, for example on the worker's desktop (not shown). The tag 200 may be of the Near-Field-Communication (NFC) type, as the tag 200 can be presented to reader 202 at short range (up to a few centimetres). When this is done, and a valid tag 200 has been recognised by the reader 202, a confirming message is sent (at 206) to server 208. Server 208 then checks socket 204 (via a message sent at 210) to verify that the tag 200 corresponds to the worker allocated the workstation at which the socket 204 is located, and if so, sends a command (at 210) to socket 204 that in turn switches socket 204 on. If either the tag 200 is not recognized, or the above workstation/tag check is failed, no such command is sent. Once the socket 204 permits power to be supplied, equipment plugged into socket 204 can be powered. Energy usage data monitored by socket 204 is thereafter transmitted (at 212) to server 208. The transmissions at 206, 210 and 212 may be carried out by any suitable wired or wireless technology, for example WiFi (wireless) or Ethernet (wired).

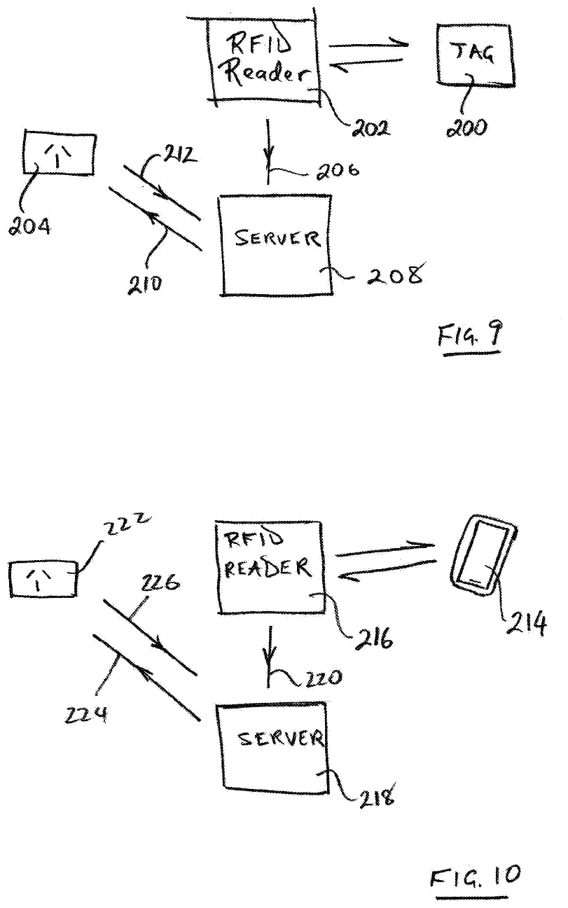

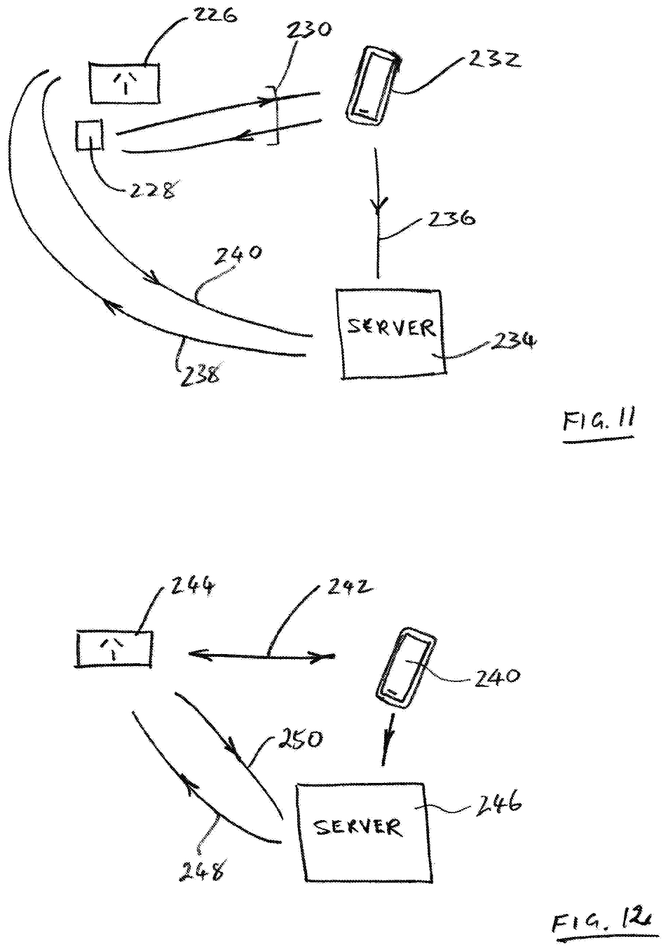

Referring now to FIG. 10, the procedure shown is essentially the same (including in respect of the communications technology) except that instead of an RFID tag such as 200, the authenticating device is a smart mobile phone 214 of the worker seeking authentication. This can be operated in RFID (and conveniently NFC) “card emulation” mode to be interrogated by reader 216. Recognition of device 214 is signalled to server 218 at 220, a check is carried out to confirm correspondence between the worker identified using device 214 and socket 226 (hence the worker's workstation), commands are sent to socket 222 from server 218 at 224, and energy usage data is transmitted to server 218 at 226. Like the scheme shown in FIG. 9, this scheme allows the authenticating reader 216 to be conveniently located, even though socket 222 may not be conveniently located.

Referring now to FIG. 11, socket 226 itself includes an RFID tag (or the like) 228 that (at 230) can be interrogated by, and respond to, a smart phone 232 operating in “reader” mode. Server 234 receives a “tag recognized” message from device 232 at 236, carried out the workstation/tag check described above, and communicates commands to socket 226 at 238 and receives energy usage data at 240. Again the communications involving the server 234 can be by any suitable technology, such as for example WiFi. Depending on accessibility of the socket 226, this scheme may not be convenient if tag 228 is of very-short-range NFC type. This problem can be overcome by use of an RFID tag 228 in one of the RFID classes that allows a larger range. The tag 228 may be of the “active” type and be powered from the electronics in the socket 226. This scheme does not require a tag reader separate from the smart phone 232.

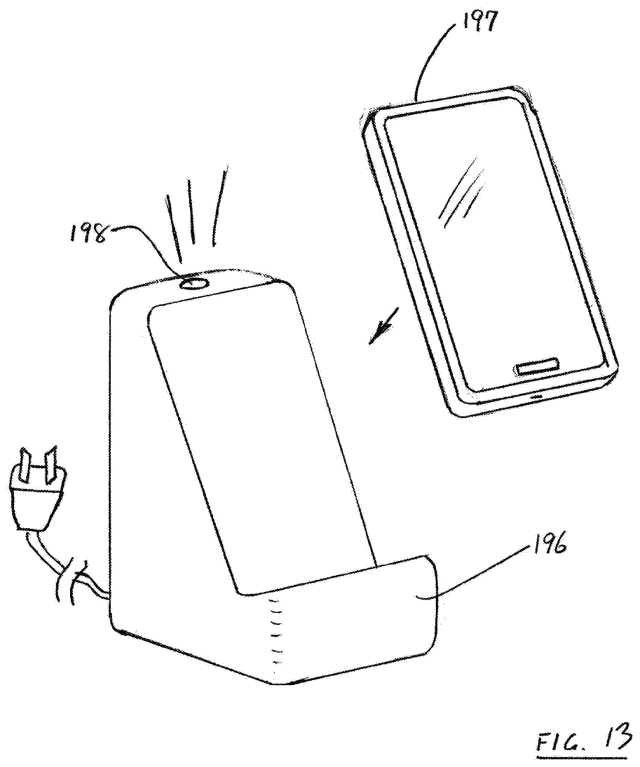

Referring to FIG. 12, authenticating device 240 is again a smart phone (or the like—see below) that is paired, and communicates (at 242) directly, with socket 244 using a suitable technology such as Bluetooth or Bluetooth Low Energy. Actual authentication in this scheme would be by means other than simple Bluetooth pairing of smart phone 240 and socket 244, such as for example entry of a password (or other identifying message) into a dedicated “app” executing on smart phone 240. On receiving such verification of the identity of the person using the smartphone, the socket would send a message to server 246, initiating a check for the correct correspondence between device 240 (or the worker associated with the entered identifying message) and socket (hence workstation), and success in that check would lead to a command being transmitted (at 248) to socket 244 to deliver power. Energy usage data for socket 244 would flow to server 246 through transmission represented at 250. As for the schemes described above by reference to FIGS. 9 to 11, any suitable communication technology may be used for the transmissions of data (at 250), commands and signals between server 246 and socket 244 (at 248). This is unlikely in offices (for example) of typical sizes to be Bluetooth, or other short-range technologies—WiFi or another longer-range technology is likely to be more suitable.

Note that although a smart phone 240 is referred to above, a computer (not shown) with a Bluetooth capability, or other suitable short range technology, may be used instead for the scheme of FIG. 12. A worker might arrive at her workstation with her laptop and authenticate using the laptop (on battery power) and then, having switched socket 244 on, plug the laptop's charger in to socket 244.

The schemes shown in FIGS. 9 to 11 are based on possession of an identifying tag, or a device that can act in essentially the same way, and that shown in FIG. 12 is based on the use of a computer or smart phone 240 that itself identifies a person and that can also be set up to require a password or other secret information to be produced. Computers and smart phones of course may also be secured by the use of fingerprint readers, facial features recognition software and the like, whose use with PDUs as described herein would further protect system 1.

Another approach to authentication is via one or several devices having a unique MAC address, which is associated with a particular user or group of users and that is able to transmit WiFi “probe request” packets that identify the particular device through its MACV address may be able to provide authentication if the PDU is able to detect the probe request packet transmissions.

A device that has MAC address randomization may still be able to be used for authentication based on the vendor prefix and the probe request sequence number providing de-anonymization.

Some other security devices are self-contained, and may be incorporated into PDUs 7 or 8 in particular, or even 9. For example, Infra-Red remote control-type devices and radio transmitters of the “garage door closer” variety can be provided that enable a coded signal to be sent to a remote device over a range of several metres, thus enabling activation of an inconveniently located PDU by an intending user. These may be used as authentication devices, the item 120 in FIG. 2 corresponding to an appropriate receiver. Still another device that may be used is a lock-controlled switch operated by a physical key.

One way of implementing the schemes of FIGS. 10 to 12 is to incorporate the RFID tag reader (202 or 216) in a desktop device that is useful in itself, in particular a mobile phone charger such as 196 in FIG. 13. A user, on arrival at her workstation, simply places her smart phone 197 on the charger 196, which may conveniently be an inductive type charger, thus appropriately locating the smart phone 197 for use in schemes FIG. 11 or 12.

In some embodiments, the charger 196 plugs into and draws power (mains or alternatively from a provided USB port) from the PDU (type 7, 8 or 9) being activated (or a power strip connected thereto). In this case, the actual phone charging function may be disabled until the PDU is activated and delivering power, with enough power for authentication being provided by a small internal battery (not shown). For the scheme of FIG. 10, the desktop charger 196 would include the RFID reader 216.

For the authentication schemes shown in FIGS. 9 and 10, charger 196 may conveniently incorporate the reader (202, 216). A user leaving his workstation for a comfort break or the like will likely take his mobile phone with him, so with the schemes of FIGS. 10-12 at least, triggering of an absence from the workstation can be sensed automatically. System 1 then implements through server(s) 11 the appropriate rule for dealing with this absence, for example making no disconnection for a predetermined period.

Charger 196 has a further feature, namely an infra-red LED 198 or other device capable of emitting infra-red radiation upward, and arranged to do so when the mobile phone 197 (and likely its owner) is present. This radiation can trigger other devices equipped to respond to the emitted radiation. For example, lighting systems (not shown) are known in which lighting over a particular location (such as a workstation) is turned on only when triggered in response to a person's presence. In the discussion above, lighting system 6 was treated as a simple shared system, with no ability to distinguish between different individuals' usage, but charger 196 and LED 198 allow this limitation to be overcome. Thus some lighting energy usage can be ascribed to an individual user.

It is possible further that charger 196, or another device adapted to sense the presence of their mobile phone 197, could trigger functions of other systems. For example, unlike HVAC system 4, an HVAC system (not shown) might be arranged to deliver less ventilating air to a workstation where an excessively prolonged absence of a mobile phone 197 indicated its owner's absence from the workstation.

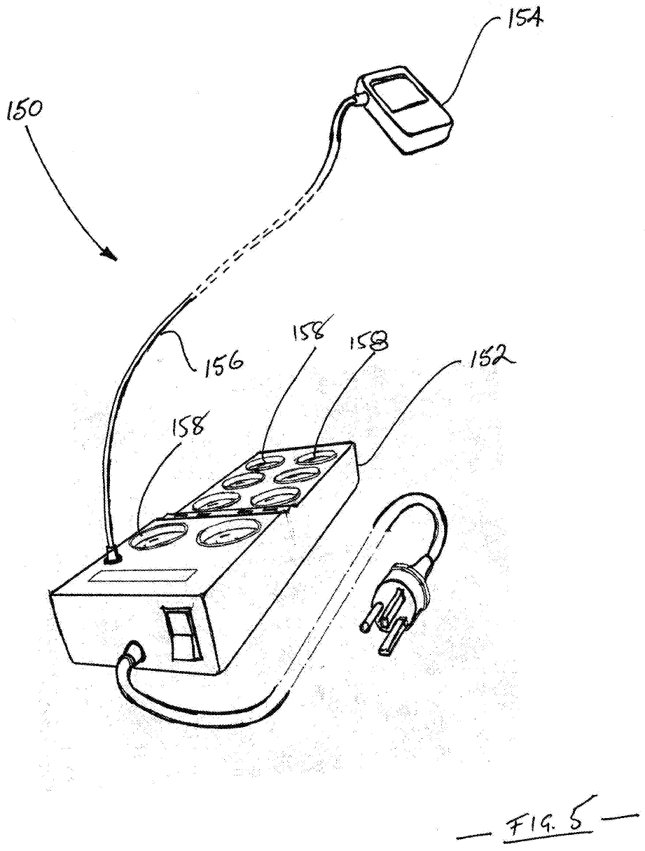

Still further arrangements are possible. FIG. 5 shows an electric power distribution unit 150 that is functionally the same as electric power distribution unit 7 but differs in that the authentication means has a sensing portion 154 housed not in the casing 152 that contains power outlet sockets 158, but instead is remote from housing 152 and connected thereto by a cable 156. This arrangement also has the advantage over power distribution unit 7 that housing 152 can be located in a hard-to-access position (for example on the floor under a desk or workbench) while the authentication means sensing portion154 is located where it can be reached conveniently by a user. Sensing portion 154 may be a simple keypad, a self-contained fingerprint reader, or a NFC tag reader, for example.

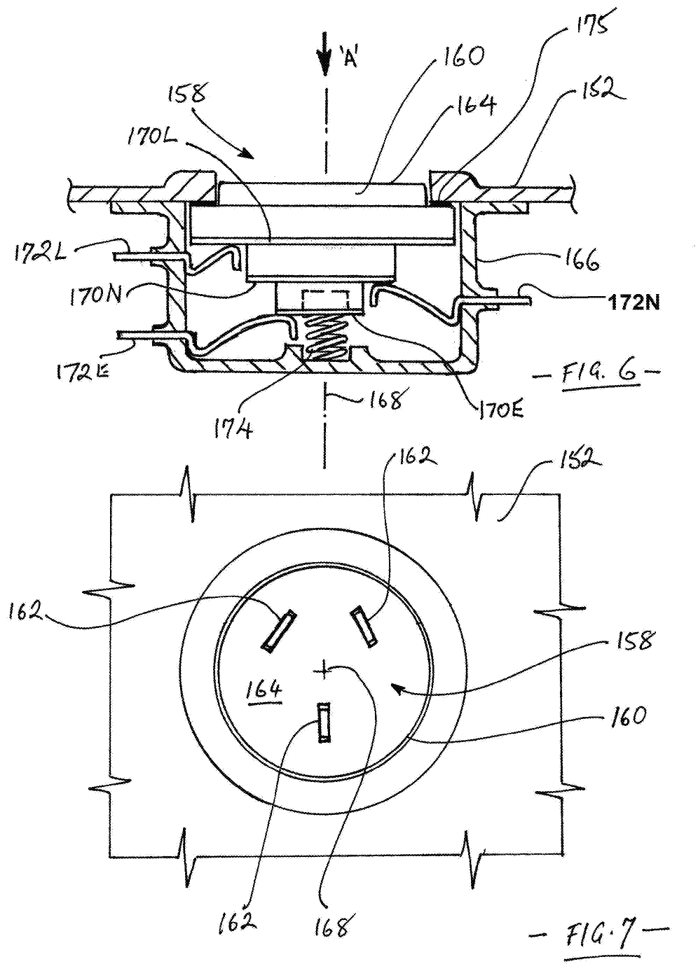

A problem with power distribution units such as for example 7 and 150 (and conventional power strips also) is that the power outlet sockets 116, 158 may not be conveniently oriented for use with the plugs and power leads (not shown) of multiple connected devices. This can be addressed by providing sockets that are rotatable within the power distribution unit. Taking power distribution unit 150 as an example, FIGS. 6 and 7 show one way in which this can be achieved. The improvements addressing this and described herein may be applied to power strips, wall sockets and the like, even of conventional type.

A socket 158 (i.e. pin receptacles 162 with internal contacts (not shown) extending inward from a surface 164) is comprised in an assembly 160 that is rotatable about an axis 168 relative to housing 152 and held inside housing 152 in a receptacle 166. Assembly 160 (which may for example be formed by injection moulding in a suitable plastic material) comprises three conductive slip rings 170L, 170N and 170E respectively that are concentric with axis 168 and internally connected to the contacts in “live”, “neutral” and “earth” pin receptacles 162. Resiliently biased against slip rings 170L, 170N and 170E (i.e. pushing upwards as drawn in FIG. 6) and housed in receptacle 166 are conductive contacts 172L, 172N, 172E. A spring 174 holds assembly 160 in position against housing 152 while allowing it (160) to be rotated in housing 152 and a gasket 175 prevents dust ingress without restricting rotation.

It will be understood by persons skilled in the art that alternative arrangements are possible. For example, each of the slip rings 170L, 170N and 170E may be contacted by multiple contacts instead of the single ones 172L, 172N and 172E. Different angular dispositions of contacts 172L, 172N and 172E around axis 168 than the one shown in FIG. 6 may be used.

It would be possible in a different arrangement (not shown) to provide slip rings that are fixed in housing 152 with contacts (functionally equivalent to contacts 172L, 172N and 172E) on a rotating assembly otherwise similar to assembly 160.

Instead of using slip rings to enable continuous rotation, flexible wires (not shown) each fixed at one end in housing 152 and at the other end to a contact of one pin receptacle (the same as 162) in a rotating assembly otherwise equivalent to assembly 160 could be used to enable a limited degree of rotation. Fixed stops (not shown) would be required to avoid over-rotation in this case.

PDU 7 (and PDUs 8 and 9) may be provided with power outlets of several types. For example, in addition to outlet(s) for nominal 240V or 115V AC the power distribution unit may have one or more USB-compatible outlets provided with 5V DC for charging of mobile phones, personal computers or tablets, and the like. The direct current supply may come from the power supply provided for the control means.

Some additional enhancements will now be disclosed.

The disclosures above of power distribution units (PDUs) such as 7, 8 and 9 have related to switching and monitoring of electric power only. However, it is possible to extend the concept to switching of water or gas supplies. A solenoid-operated valve (not shown) for gas or water may be operated using the same principle and componentry disclosed above in relation to PDU 7. That is, power would be switched on after authentication, and operate the valve directly or via a relay or solid-state switch. The concept may be extended further by providing flow sensors to measure the gas or water supplied. Then the approach mentioned above in relation to FIG. 4 would be applied to arrive at greenhouse gas emissions or other derived quantities associated with the measured flows. This system 1 could actually include switched and monitored supplies of water and gas.

Still another possible extension of the concepts set out above is as follows. Instead of a system such as system 1 based on server(s) 11 separate from the PDUs, and networked with them, it is possible to provide within a PDU such as 7, 8 or 9 (or a “utility switch” as disclosed in the previous paragraph) a more powerful computer able to carry out at least some of the functions of server(s) 11 entirely within the PDU. The functions may for example include authentication, logging of energy/power usage (or usage of water or gas) and control of the PDU. A number of such PDUs may be networked together to synchronize (for example) user databases held in each PDU, and/or for periodic collation of data from multiple PDUs. In summary, an alternative to system 1 may be a system broadly similar except that the computing and storage power that is concentrated in sever(s) 11 in system 1 is distributed among multiple PDUs.

1. A system for distributing and monitoring usage of energy comprising:
at least one power distribution unit connectable to an energy source and to one or more energy-consuming devices, and adapted to monitor energy distribution from the energy source through the or each power distribution unit;
at least one server in communication with the at least one power distribution network via a data network, the server being adapted to receive through the data network data on energy distributed by the or each power distribution unit to the energy-consuming devices,
wherein:
the at least one server maintains databases of authorized users and nominated groupings of authorized users of the system and is adapted to enable distribution of energy through commands sent to the or each power distribution unit over the data network;
said commands are sent on authentication of an authorized user by the at least one server in response to detection of an identifying device associated with the authorized user by the power distribution unit and communication of the detection to the at least one server; and
the at least one server is adapted to use received data from the or each power distribution unit to determine and record energy usage by individual authorized users or groupings of users.

2. The system according to claim 1 wherein the at least one server is adapted to estimate and report greenhouse gas emissions associated with energy usage of individual authorized users and said nominated groupings of authorized users.

3. The system according to claim 1 wherein the at least one server is adapted to monitor supply from any of gas, water and other non-electricity utilities by individual users and said nominated groupings of users, and to derive estimates of greenhouse gas emissions associated therewith using information received and maintained by the at least one server.

4. The system according to claim 1 wherein the at least one server is provided with and maintains a set of rules for apportioning among users responsibility for:
energy supplied from the energy source that is not monitored by the or each power distribution unit and greenhouse gas emissions associated therewith as estimated by the system; and
any supplies from any of gas, water or other non-electricity utilities not monitored at individual-user level and greenhouse gas emissions associated therewith as estimated by the system.

5. The system according to claim 1 wherein the at least one server is further adapted to receive data from bank accounts or authorized users, and to derive estimates of energy or greenhouse gas emissions based on the bank account data.

6. The system according to claim 1 wherein the or a said power distribution unit comprises a first portion having one or more electrical power outlets and a second portion positionable at a point accessible to an intending user the second portion being connected physically to the first portion and adapted for use by the intending user to enter identifying information or to present an identifying item adapted to identify an intending user to the system.

7. The system according to claim 1 wherein the or a said power distribution unit comprises a first portion having one or more electrical power outlets and a second portion positionable at a point remote from the first portion the second portion being adapted for use by the intending user to enter or derive from an identifying item information identifying an intending user to the system and to transfer the said information wirelessly to the power distribution unit.

8. The system according to claim 1 wherein:
the system comprises a Radio Frequency Identification (RFID) device reading device adapted to communicate over the data network with the at least one server and on detection of an RFID tag or a device in RFID “card emulation” mode to send a message to the at least one server seeking authentication as an authorized user by the at least one server and actuation of the or a said power distribution unit allocated to the authorized user.

9. The system according to claim 8 wherein the RFID device and the RFID tag or device in card emulation mode are of Near Field Communication (NFC) types.

10. The system according to claim 1 wherein:
the or a said power distribution unit comprises an RFID tag;
the server is adapted to receive a message transmitted by a device held by an intending user that can read the RFID tag and that identifies the power distribution unit and the intending user, whereby to authenticate the intending user as an authorized user and to send a command to the power distribution unit comprising the RFID tag to enable provision of power therefrom.

11. The system according to claim 10 wherein the RFID tag and the device that reads the RFID tag are of Near Field Communication (NFC) type.

12. The system according to claim 1 wherein:
the or a said power distribution unit is adapted to be paired for digital communication with a device held by an intending user and thereby to receive identification data of the intending user from the device;
the power distribution unit is adapted on receipt of said identification data to send a message over the data network to the at least one server seeking authentication of the intending user as an authorized user.

13. The system according to claim 12 where pairing of the power distribution unit and the user-held device is by means of a short-range wireless communication protocol, preferably Bluetooth or Bluetooth Low Energy.

14. The system according to claim 8 wherein the RFID reading device is comprised in a mobile phone charging device adapted to have a mobile phone placed thereon for communication with the RFID reading device.

15. The system according to claim 14 wherein the server is adapted to store and apply a rule for responding to removal of the mobile phone from the mobile phone charging device.

16. The system according to claim 8 wherein the RFID reading device is associated with the or a particular power distribution unit and authentication of an intending user by the at least one server comprises:
checking that the intending user is an authorized user; and
checking that the authorized user is authorized to use the power distribution unit associated with the RFID reading device.

17. The system according to claim 12 wherein the server stores a correspondence between an authorized user and the or a particular power distribution unit and when an authentication request is received, checks both whether an intending user is an authorized user of the system and whether the request has been transmitted from the power distribution unit corresponding to that authorized user.

18. A method for distributing and monitoring usage of energy comprising:
providing and operating a system according to any one of claim 1.
